(19) United States
(12) Patent Application Publication
(10) Pub. No.: US 2022/0174353 A1
(43) Pub. Date: Jun. 2, 2022

(54) ENGAGEMENT ESTIMATION APPARATUS, ENGAGEMENT ESTIMATION METHOD AND PROGRAM

(71) Applicant: Nippon Telegraph and Telephone Corporation, Tokyo (JP)

(72) Inventors: Kazuhisa YAMAGISHI, Tokyo (JP); Pierre LEBRETON, Tokyo (JP)

(21) Appl. No.: 17/430,393

(22) PCT Filed: Feb. 6, 2020
(86) PCT No.: PCT/JP2020/004566

§ 371 Date: Aug. 12, 2021

(30) Foreign Application Priority Data
Feb. 20, 2019 (JP) 2019-028463

(51) Int. Cl. H04N 21/442; H04L 65/80; H04L 65/60

(52) U.S. Cl. CPC H04N 21/44204; H04L 65/601; H04L 65/80

(57) ABSTRACT

An engagement estimation apparatus includes an acquisition unit configured to acquire, when stalling of a video delivered through a network occurs, a stalling position at occurrence of the stalling and a duration of the stalling, and an estimation unit configured to calculate an estimation value of an index for evaluation of engagement based on a property that the number of exited viewers increases as the stalling position is lengthened and as the duration increases. Thus, engagement can be estimated based on a parameter that can be observed in a terminal.

### TECHNICAL FIELD

The present invention relates to an engagement estimation apparatus, an engagement estimation method and a program.

### BACKGROUND ART

Communication services (voice communication, video communication, Web, IoT, and the like) that transmit video, sound (hereinafter including voice), text, and the like between terminals or between servers and terminals via the Internet are widespread.

The Internet is a network where communication quality is not always guaranteed, and therefore, when communicating with audio and video media, the quality that viewers perceive for audio and video media is degraded due to bit rate decrease due to narrow line bandwidth between the viewer's terminal and the network, packet loss due to line congestion, delay in packet transmission, and packet retransmission.

Specifically, in adaptive bit rate video delivery, in which the bit rate of audio and video media is changed in accordance with the network's throughput state, a reduction in sound and image quality due to a decrease in throughput, and an initial loading delay or stalling due to the buffering process that occurs because a predetermined amount of data has not been accumulated in the buffer of the receiving terminal occur.

The bit rate decrease, the initial loading delay and the stalling affect not only the quality that users experience, but also the engagement (view duration, view acceptance, stop/exit, view cancellation).

Therefore, in order to confirm that the video distribution provider is providing the above video communication services with good quality and engagement, it is important to be able to measure the quality and engagement of audio-visuals experienced by viewers during the provision of the service and to monitor the high quality and engagement of the audio-visuals provided to the viewers.

Therefore, there is a need for quality and engagement estimation techniques that can adequately indicate the audio-visual quality and engagement that viewers experience.

One example of conventional objective quality assessments includes ITU-T recommendation P.1203 disclosed in NPTL 1 and the technique disclosed in NPTL 2. The present technique estimates the quality using quality parameters such as video resolution, frame rate, bit rate, initial loading delay, and stalling length from packets received at a reception terminal (such as a smartphone and a STB (Set-Top Box)).

### CITATION LIST

### Non Patent Literature

NPL 1: Parametric Bitstream-based Quality Assessment of Progressive Download and Adaptive Audiovisual Streaming Services Over Reliable Transport, ITU-T P.1203
NPL 2: K. Yamagishi and T. Hayashi, “Parametric Quality-Estimation Model for Adaptive-Bitrate Streaming Services,” IEEE Transactions on Multimedia, 2017. DOI:10.1109/TMM.2017.2669859.

### SUMMARY OF THE INVENTION

### Technical Problem

However, if an video distributor is going to monitor engagement (view duration, view acceptance and stop/exit; hereinafter the view exit is described) using the information in a user terminal, an engagement estimation technique is required, and there is currently no such technique.

Under the above-mentioned circumstances, an object of the present invention is to estimate engagement based on a parameter that can be observed in a terminal.

### Means for Solving the Problem

To solve the above-mentioned problems, an engagement estimation apparatus includes an acquisition unit configured to acquire, when stalling of a video delivered through a network occurs, a stalling position at occurrence of the stalling and a duration of the stalling, and an estimation unit configured to calculate an estimation value of an index for evaluation of engagement based on a property that the number of exited viewers increases as the stalling position is lengthened and as the duration increases.

### Effects of the Invention

It is possible to estimate engagement based on a parameter that can be observed in a terminal.

### BRIEF DESCRIPTION OF DRAWINGS

FIG. 1 is a drawing illustrating an example of a hardware configuration of an engagement estimation apparatus 10 of an embodiment of the present invention.

FIG. 2 is a drawing illustrating an example of a functional configuration of the engagement estimation apparatus 10 of the embodiment of the present invention.

FIG. 3 is a flowchart for describing an example of a procedure of processes executed by the engagement estimation apparatus 10.

### DESCRIPTION OF EMBODIMENTS

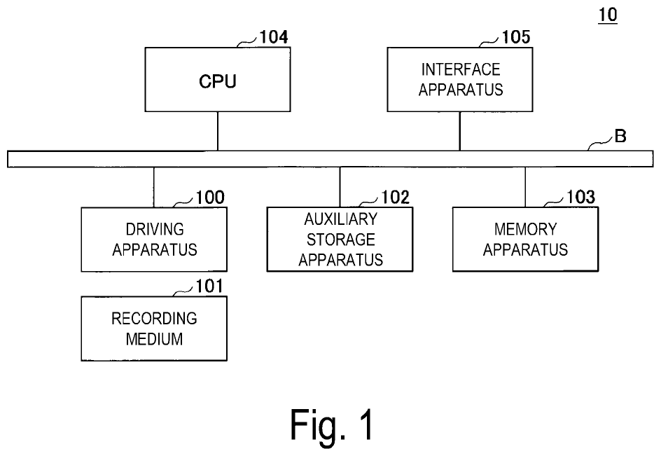

Embodiments of the present invention are described below with reference to the drawings. FIG. 1 is a drawing illustrating an example of a hardware configuration of an engagement estimation apparatus 10 of an embodiment of the present invention. The engagement estimation apparatus 10 of FIG. 1 includes a driving apparatus 100, an auxiliary storage apparatus 102, a memory apparatus 103, a CPU 104, an interface apparatus 105 and the like that are connected to one another through a bus B.

A program for implementing a process in the engagement estimation apparatus 10 is provided by a recording medium 101 such as a CD-ROM. When the recording medium 101 in which a program is stored is set in the driving apparatus 100, the program is installed to the auxiliary storage apparatus 102 from the recording medium 101 through the driving apparatus 100. It should be noted that installation of a program may not be performed from the recording medium 101, and may be downloaded from another computer through a network. The auxiliary storage apparatus 102 stores the installed program, and stores a required file, data and the like.

In response to an activation instruction of a program, the memory apparatus 103 reads the program from the auxiliary storage apparatus 102 and stores the program. The CPU 104 executes a function according to the engagement estimation apparatus 10 in accordance with a program stored in the memory apparatus 103. The interface apparatus 105 is used as an interface for network connection.

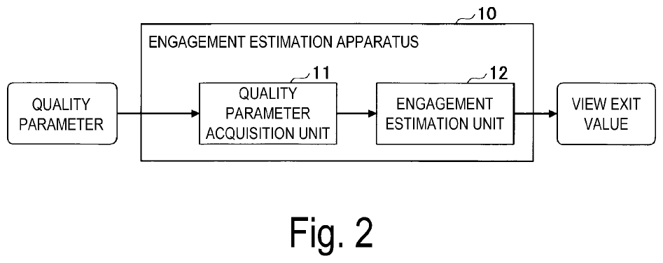

FIG. 2 is a drawing illustrating an example of a functional configuration of the engagement estimation apparatus 10 of the embodiment of the present invention. In FIG. 2, the engagement estimation apparatus 10 includes a quality parameter acquisition unit 11, an engagement estimation unit 12 and the like to estimate engagement (view exit) that a viewer finally felt for adaptive bit rate video delivery performed through a network. These units are implemented by processes executed at the CPU 104 based on one or more programs installed in the engagement estimation apparatus 10. Specifically, these units are implemented by a cooperation of hardware resources of the engagement estimation apparatus 10 and programs (software) installed in the engagement estimation apparatus 10.

For example, when a start of a view of a video of adaptive bit rate video delivery is instructed, the quality parameter acquisition unit 11 acquires parameters (hereinafter collectively referred to as “quality parameter”) related to the video viewing state such as the stalling length (the duration of the stalling) and the stalling position in addition to parameters related to the coding quality such as the resolution, the frame rate, and the bit rate in the measurement section, for example, from an application playing the video and the like for each measurement section set in advance, for example. The above-mentioned measurement section set in advance is, for example, a time unit such as one second, one minute, five minutes, and one hours, or a chunk/segment unit used for video delivery. Note that in the present embodiment, the concept of the stalling length also includes the initial loading delay (the time until a playback of a video is started after the playback is instructed). The reason for this is that the stalling and the initial loading delay have in common that the playback is in a stopped state for the viewer. In addition, the stalling position refers to the playback position of the video at occurrence of stalling. For example, the stalling position in the case where initial loading delay occurs is 0 second.

Stalling (including initial loading delay) occurs due to exhaustion of data accumulated in the buffer of the terminal (viewer terminal) used for the view, and the stalling is terminated (that is, a playback is started or restarted). Then, the engagement estimation unit 12 calculates an estimation value of an index for evaluation of the engagement (hereinafter referred to as “view exit value”) based on the quality parameter acquired by the quality parameter acquisition unit 11 up to the termination of the stalling. In the present embodiment, the number of persons exited from the view (hereinafter referred to as “exited viewer”) is set as the index. To be more specific, the view exit rate is described as an example of the view exit value. It should be noted that another index value, such as an video view duration at a time point of exit from the view, may be used as the view exit value.

It is to be noted that the engagement estimation apparatus 10 is, for example, a computer (viewer terminal) used for a view of adaptive bit rate video delivery. To be more specific, a smartphone, a tablet terminal, a personal computer (PC) and the like may be used as the engagement estimation apparatus 10.

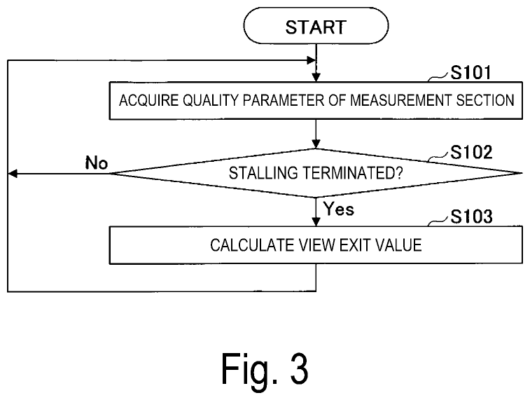

A procedure of processes executed by the engagement estimation apparatus 10 is described below. FIG. 3 is a flowchart for describing an example of a procedure of processes executed by the engagement estimation apparatus 10.

At step S101, the quality parameter acquisition unit 11 acquires a quality parameter in an immediately preceding measurement section. The step S101 is repeated until the stalling is completed (a playback is started or restarted) after the stalling occurs.

Thereafter, when the buffer of the viewer terminal is exhausted and stalling occurs, and the stalling is terminated (Yes at S102), the engagement estimation unit 12 calculates the view exit rate based on the quality parameter acquired by the quality parameter acquisition unit 11 up to the termination of the stalling (S102). Subsequently, the process is returned to step S101.

In the procedure of processes of FIG. 3, each time stalling occurs, the view exit rate due to the occurrence of the present stalling is calculated. To be more specific, the engagement estimation unit 12 calculates the view exit rate based on the following Equation (1).

User.Drop=A×StallDur+B×Stall.Pos+C+MOS×User.Alr.Quit(E×F×Stall.Pos) (1)

It should be noted that the meaning of each parameter is as follows.
User.Drop: the view exit rate due to the present stalling
StallDur: the stalling length of the present stalling
Stall.Pos: the stalling position at the time of occurrence of the present stalling
User.Alr.Quit: in a case where stalling has occurred multiple times, the view exit rate due to the stalling before this stalling (that is, it is 0 when stalling has occurred one time)
MOS: the video quality (coding quality) immediately before occurrence of stalling, and the higher the video quality, the larger the value.
A, B, C, E, F: coefficients
It is to be noted that User.Alr.Quit can be calculated based on the history of the view exit rate calculated at step S102. In addition, MOS can be calculated based on parameters related to the coding quality such as the resolution, the frame rate and the bit rate acquired by the quality parameter acquisition unit 11 for the measurement section at occurrence of stalling. For example, MOS may be a value output by a quality estimation technique such as ITU-T recommendation P.1203, or a value calculated with other publicly known techniques such as the method disclosed in WO2017/104416 or the like. It should be noted that in the case of the initial loading delay (that is, in the case where the playback has not yet started), the value of MOS is 0. A, B, C, E, and F may be determined through an experiment and the like, for example.

A meaning (basis) of Equation (1) is elaborated below.

The number of exited viewers (that is, the view exit rate) tends to be larger as the stalling waiting time increases. Likewise, the view exit rate at occurrence of stalling tends to be larger as the stalling position is lengthened (increased). This property is expressed by “A×StallDur+B×Stall.Pos”.

In addition, the view exit rate at occurrence of stalling is influenced also by the view exit rate due to one previous (previously occurred) stalling. That is, the higher the view exit rate due to the previous stalling, the higher the view exit rate of the present stalling. In addition, also in the case where stalling has occurred multiple times, the view exit rate is influenced also by the stalling position as in the case where stalling has occurred one time. Further, the view exit rate is influenced also by the video quality at occurrence of stalling. To be more specific, the influence on User.Drop is larger when the quality is higher at occurrence of stalling in a previous time, and therefore the historical influence is larger when MOS is higher. These properties are expressed by “MOS×User.Alr.Quit (E×F×Stall.Pos)”.

Two specific examples are described below.

### Ex. 1: Case where Stalling has Occurred One Time

In the case where stalling has occurred one time, User.Alt.Quit has no value, and therefore User.Drop is calculated in the terms up to C. For example, in the case where stalling of ten seconds has occurred at the 30th second,

User.Drop=A×10+B×30+C

is calculated.

### Ex. 2: Case where Stalling has Occurred Two Times

In the case where stalling has occurred two times, User.Alt.Quit has a value for the first stalling. For example, assume that in a case where stalling of ten seconds has occurred at the 30th second and stalling of ten seconds has occurred at the 60th second, the User.Drop (=User.Alt.Quit) of the stalling at the 30th second (that is, the first stalling) is 30%, and the MOS immediately preceding the second stalling is 5. In this case,

User.Drop=A×10+B×60+C+5×30×(E−F×60)

is calculated.

It is to be noted that in the terms on the right side of C (MOS×User.Alr.Quit(E×F×Stall.Pos)), the influence of the viewer who has already exited in the previous stalling is taken into consideration.

That is, as is clear from “A×10+B×60+C”, this is only the influence at the occurrence of the second stalling. If the influence before the occurrence of the second stalling, that is, the influence of the occurrence of the first stalling, is added as it is, User.Drop is excessively evaluated, and therefore, the terms “5×30×(E−F×60)” are provided. In addition, since the influence on User.Drop is larger when the quality is higher at occurrence of stalling, the historical influence is larger when MOS is higher. The reason for this is that when stalling suddenly occurs during high quality viewing, the degradation recognized by the viewer is significant, whereas when stalling occurs during low quality viewing, the degradation recognized by the viewer is not so significant because the quality is originally low. Such identification was verified through an experiment by the present inventor.

Although all of the above equations are based on multiple regression equations, for example, parameters such as StallDur, Stall.Pos, and User.Alr.Quit may be modeled by nonlinear regression (e.g., power function) to derive the view exit rate.

As described above, according to the present embodiment, engagement can be estimated based on parameters that can be observed in a terminal, such as the resolution, the frame rate, the bit rate, the stalling length, and the stalling position.

As a result, for example, by monitoring the engagement value of a communication service actually viewed by a viewer, whether the service being provided maintains engagement of a certain level or greater for the viewer can be easily determined, and the actual engagement of the service being provided can be determined and managed in real time.

It is to be noted that in the embodiments, the quality parameter acquisition unit 11 is an example of an acquisition unit. The engagement estimation unit 12 is an example of an estimation unit.

Although the embodiments of the present invention have been described above in detail, the present disclosure is not limited to such specific embodiments, and various modifications or changes can be made within the scope of the gist of the present disclosure described in the claims.

### REFERENCE SIGNS LIST

10 Engagement estimation apparatus
11 Quality parameter acquisition unit
12 Engagement estimation unit
100 Driving apparatus
101 Recording medium
102 Auxiliary storage apparatus
103 Memory apparatus
104 CPU
105 Interface apparatus
B Bus

1. An engagement estimation apparatus comprising:
an acquisition unit, including one or more computing devices, configured to acquire, when stalling of a video delivered through a network occurs, a stalling position at occurrence of the stalling and a duration of the stalling; and
an estimation unit, including one or more computing devices, configured to calculate an estimation value of an index for evaluation of engagement based on a property that a number of exited viewers increases as a stalling position is lengthened and as the duration of the stalling increases.

2. The engagement estimation apparatus according to claim 1, wherein the estimation unit further calculates the estimation value for a present stalling based on the estimation value calculated for previously occurred stalling.

3. The engagement estimation apparatus according to claim 2, wherein
the acquisition unit further acquires a value indicating quality of the video before the occurrence of the stalling; and
the estimation unit further calculates the estimation value for the present stalling such that when the quality is higher, an influence of the estimation value calculated for the previously occurred stalling is larger.

4. An engagement estimation method comprising, at one or more computers:
acquiring, when stalling of a video delivered through a network occurs, a stalling position at occurrence of the stalling and a duration of the stalling; and
calculating an estimation value of an index for evaluation of engagement based on a property that a number of exited viewers increases as a stalling position is lengthened and as the duration of the stalling increases.

5. The engagement estimation method according to claim 4, wherein calculating the estimation value of the index for evaluation of engagement further includes calculating the estimation value for a present stalling based on the estimation value calculated for previously occurred stalling.

6. The engagement estimation method according to claim 5, wherein
acquiring the stalling position at occurrence of the stalling and the duration of the stalling further includes acquiring a value indicating quality of the video before the occurrence of the stalling; and
calculating the estimation value of the index for evaluation of engagement further includes calculating the estimation value for the present stalling such that when the quality is higher, an influence of the estimation value calculated for the previously occurred stalling is larger.

7. A non-transitory computer readable medium comprising a program configured to cause a computer to execute an engagement estimation method comprising:
acquiring, when stalling of a video delivered through a network occurs, a stalling position at occurrence of the stalling and a duration of the stalling; and
calculating an estimation value of an index for evaluation of engagement based on a property that the number of exited viewers increases as the stalling position is lengthened and as the duration increases.
